(19) United States
(12) Patent Application Publication
(10) Pub. No.: US 2011/0011529 A1
(43) Pub. Date: Jan. 20, 2011

(54) Removable adhesive for adhering an image to a surface and a method for removing the image

(76) Inventor: Donald C. Warren, Carrollton, GA (US)

Correspondence Address: BRUCE L. ADAMS, ESQ;ADAMS & WILKS, SUITE 1231, 17 BATTERY PLACE, NEW YORK, NY, 10004, US

(21) Appl. No.: 12/924,265

(22) Filed: Sep. 23, 2010

Related U.S. Application Data
(63) Continuation of application No. 11/599,881, filed on Nov. 14, 2006, now abandoned.
(60) Provisional application No. 60/736,487, filed on Nov. 14, 2005.
(60) Provisional application No. 60/736,421, filed on Nov. 14, 2005.

(51) Int. Cl. B32B 38/10; B32B 37/12; C08L 75/04

(52) U.S. Cl. 156/247; 156/331.7; 156/390; 524/507

(57) ABSTRACT

A removable adhesive of a combination of acrylic and urethane polymers is provided for securing, among other things, a transfer image to a hard surface. A removable top coat is provided. A top coat comprising a cellulose acetate butyrate alcohol and a diacetone alcohol is provided. A remover for removing the transferred image is provided which is a combination of tetrahydrofuryl alcohol and a dibasic ester and a surfactant.

### CROSS-REFERENCE TO RELATED APPLICATION

This application claims priority to copending U.S. provisional application entitled, “A Removable Paint Formulation and System,” having Ser. No. 60/736,487, filed Nov. 14, 2005, which is entirely incorporated herein by reference and U.S. provisional application entitled, “A Water Based Removable Paint Formulation and System,” having Ser. No. 60/736,421, filed Nov. 14, 2005 which is also entirely incorporated herein by reference.

### TECHNICAL FIELD

This invention relates to a removable adhesive for adhering an image to a painted or unpainted surface. This adhesive adheres the image to the painted or unpainted surface but permits its easy removal without damage to the painted or unpainted surface. A compatible coating is also provided for protecting the image.

### BACKGROUND OF THE INVENTION

It is desirable to have a water release paper with an image for applying to a painted or unpainted surface that can be easily removed without damaging the surface. This is especially useful for putting temporary images on the painted surface of an automobile. There are numerous adhesives available for securing an image on a water release paper to a painted surface, but removal of the image usually results in damage to the painted surface.

Traditionally, the transfers of images, or, as they are known within the industry, decals, are of two types: those which have a dry release and those which have a wet release. This invention is principally related to images with wet release; those which are available in the market and have an image printed on a paper which has previously been covered with a layer soluble in water. When the image is soaked with water and pressed on a surface on which the image is to appear, this layer dissolves and becomes soft, so that the paper may be removed, leaving the image on the desired surface.

The paper on which the image is printed is known as a wet release paper, normally made up of a paper of good quality which is coated with a water soluble emulsion, e.g. starch and gum. Such water release or slide paper usually includes an absorbent paper which is coated with a water soluble vegetable gum and starch release layer. The paper or backing serves as a support for the release layer and subsequent layers.

The image may be printed on the paper with known methods, such as offset printing, screen printing, copying or drawing directly or in reverse, depending on the final surface. Normally, the printer begins by application of a topcoat of lacquer or varnish on the release paper surface. Thereafter, he prints the image on the lacquer and an adhesive (e.g. pressure sensitive) is applied and dried.

Before applying the image, it is submerged in water for a short while; whereafter the image is applied in its exact position and the paper is slid off. The sliding-off results from the dissolution in water of the decal's water soluble layer.

It is normally transferred to a permanent substrate such as an automobile windshield, or any metallic item to be decorated, by wetting, and removing the decalcomania backing.

The image to be transferred is printed on the release layer or topcoat with a wide variety of non-water soluble inks. The image can be applied by silk screening, offset printing, or toner based laser printout. Thereafter a continuous film of non-water soluble lacquer is applied over the entire image by silk screening or other methods known in the art which yield a relatively uniform coating. The coating is permitted to dry. An adhesive is then applied and dried. After drying, the decal is relatively secure for stacking and shipping with one side being reinforced by the backing, and the other side being reinforced by a topcoat.

In use, the decal as just described is soaked in water. After a few moments it will become apparent that the decal can be removed from the release layer. At this point the decal and “transfer” is moved as close as possible to the final location where the graphic is to be applied. Thereafter, the image is slidably removed from the support to its final location. The image must be moved very carefully on a cushion of water to its exact location. If air bubbles are trapped under the film, they should be removed by a squeegee or other rubbing action. Thereafter the image is permitted to dry.

### SUMMARY OF THE INVENTION

A removable adhesive is provided for adhering an image to a hard surface and a top coating is provided for protecting the image. The adhesive consists of from 19 to about 34% of an acrylic polymer and 0.24 to 5% of an aliphatic water-borne urethane polymer and from 0.06 to 0.6% of an alkali active matter and water. Preferably the (a) acrylic polymer consists of approximately 22% by dry weight of an acrylic polymer having an acid number of approximately 65 and a hardness temperature (Tg) of 28° C. and approximately 4% by dry weight of an acrylic polymer with an acid number of approximately 32 and a hardness temperature (Tg) of 24° C., and a urethane polymer (b) has a viscosity (cP) in dispersion of approximately 125 and a pH of 8+/−1 and is present in an amount of approximately 0.7% by dry weight and the alkali (c) is ammonium hydroxide that is present in an amount of 0.3% by weight of active matter as needed to achieve a pH of the composition between 8 and 8.5, from 5 to 25% by weight of an ester alcohol and 5 to 20% of diacetone alcohol can be added to this adhesive to improve its application properties.

A top coating is provided which consists of approximately 20 to 30% by weight of cellulose acetate butyrate, 50 to 80% by weight of ethyl alcohol and 10 to 30% by weight of diacetone alcohol.

The transfer image of this invention is applied in the conventional way by wetting the adhesive and then adhering it to the hard surface. This image can easily be removed by a remover that consists of from 70 to 90% by weight of tetrahydrafuryl alcohol, 5 to 10% by weight of a dibasic ester and from 0.2 to 1% by weight of an emulsifying surfactant and using the removal techniques of agitating the decal and waiting for the remover solution to act in order to remove the decal.

### BRIEF DESCRIPTION OF THE DRAWING

FIG. 1 is a cross-section view of the transfer image decal of this invention.

### DETAILED DESCRIPTION OF THE PREFERRED EMBODIMENT

A water based removable adhesive for adhering an image to an unpainted or a painted surface such as a painted panel of a car, has been developed. This adhesive will adhere a painted or printed image on a lacquer of this invention applied to a decal to a painted or unpainted surface. Once the paper backing of the decal has been removed and the image has been adhered to the painted surface and dried, it can be easily removed by solvents that do not damage the painted surface. These transfer images have a paper back and are basically a water slide decal paper. After they have been printed with the appropriate image, the adhesive of this invention can be applied and dried. The transfer image can be applied to a painted surface and the paper backing slide off.

This water-based removable adhesive is a carefully balanced formula of acrylic polymers and a urethane polymer. The combination is neutralized with an alkali. Ammonium hydroxide is preferred. Acrylic polymeric colloidal dispersions such Carboset® 514-H, manufactured by Noveon, Inc., are used in the water-based removable adhesives of the present invention. This dispersion has 40% by weight solids and is supplied in ammonia water and has a pH of between 6.6 and 7.4. The Carboset® 514-H has a relatively high acid number of about 65 and hardness temperature (glass transition) (Tg) of about 28° C.

Preferably another acrylic polymeric colloidal dispersion is also used to obtain the correct balance of hardness and acidity. Carboset® 519 has 40% by weight solids and has been found to be useful. Carboset® 519 has lower acid number of about 32 and hardness temperature (Tg) of 24° C., and a pH of between 7.9 and 8.7. The combined effect of the properties of these two acrylic polymers provides the right degree of adhesion, alkali resistance and flexibility of the adhesive. This combination is especially useful to permit the easy removal or loosening of the adhesive but yet insure adequate adhesion and flexibility prior to removal of the decal or the image from the painted surface. The combination of the Carboset® 514-H and 519 is especially important because the dried 514-H is more readily dissolved compared to the 519 because the 514-H has a higher acid number. Thus, when the remover of this invention is applied to the adhesive of this invention it will start dissolving the 514-H component of the adhesive first and then proceed on to dissolving the 519 and allowing the adhesive to be removed from the painted surface or loosening of the adhesive sufficiently so that the image can be removed.

The acrylic polymers can be neutralized by caustic soda, caustic potash, amines, alkanol amines or ammonia, which is preferred.

A polyurethane is included in the adhesive. Polyurethane provides a hardness as well as flexibility to the adhesive. The preferred polyurethane is Sancure® 815, which is manufactured by Noveon, Inc. as a dispersion of 35% solids and has a viscosity (cP) of about 125 with a pH of 8+/−1. It has a Sward hardness of 70. The properties of alkali resistance, adhesion properties, flexibility, surface hardness and tackiness can be balanced by adjusting the amount of Carboset® 514, 519 and polyurethane in the formulation. The Sancure® 815 is hard, but flexible and with a high tensile strength which improves the quality of the adhesive. The Sancure® 815 has a high resistant to alkali and detergent. A small quantity of the Sancure® 815 gives the final adhesive the necessary hardness.

The adhesive of this invention can also include optional ingredients such as preservatives, biocides, thickeners and the like. Proxel GXL has proven to be a good preservative and biocide. These additional ingredients are not critical to the function of the adhesive but aid in improving the commercial utility and have other advantages.

A dispersion of the adhesive of the present invention preferably comprises:

| COMPONENT | % BY DRY WEIGHT |
|---|---|
| Acrylic polymer | 19-34 |
| Polyurethane | 0.2-4 |
| Ammonium hydroxide | 0.06-0.6 (active content) |
| Water | Balance |

A dispersion of a preferred adhesive composition comprises:

| COMPONENT | % BY DRY WEIGHT |
|---|---|
| Acrylic polymer | 22-30 |
| Polyurethane | 0.4-1.2 |
| Ammonium hydroxide | 0.06-0.3 (active content) |
| Water | Balance |

A mixture of acrylic polymers provides the optimum characteristics for the adhesive. It has been found that from 19 to 26% by dry weight of an acrylic polymer with an acid number of between 60 and 70 and a hardness temperature (Tg) of between 26° C. and 30° C. mixed with 2.4 to 16% by dry weight of an acrylic polymer with an acid number of between 28 and 34 and a hardness temperature (Tg) of between 22° C. and 26° C. results in a good balance of the acrylic polymers. This is preferably mixed with from 0.4 to 1.23% by dry weight of polyurethane with a viscosity (cP) of 120 to 130 and pH of 8+/−1.5 to achieve a good balance of the characteristics of good adhesive, surface hardness and ease of removal with a removal formulation.

It is important that the mixture of the acrylic polymers and polyurethane be carefully balanced. The acrylic polymer with a high acid number has a large number of carboxyl groups which react with the hydroxyl groups provided by the ammonium hydroxide and other sources facilitating the removal or loosening of the adhesive by the remover composition. On the other hand the acrylic polymer with the low acid number has fewer carboxyl groups and are more resistant to attack by hydroxyl groups which helps preserve the stability of the adhesive. Having acrylic polymers with different hardness numbers is also balanced to make sure the adhesive has sufficient hardness to stand general use but can be easily removed by the remover compositions. The polyurethane provides a hard surface and resistance to attack by hydroxyl groups. Molecules of the acrylic and polyurethane polymers are intermixed throughout the adhesive which provides the delicate balance between hardness and amorphous states, resistance to attack and ease of removal by hydroxyl groups. This balance is achieved by a formulation that contains approximately about 22% of Carboset 514-H, 4% Carboset 519 and 0.7% Sancure 815 and 0.3% ammonium hydroxide, based on dry weight.

The adhesive of this invention is prepared by mixing the acrylic dispersions and the polyurethane dispersions with water and adjusting the pH to between 8 and 8.5 preferably using ammonium hydroxide. Additional water is then added.

Increasing the amount of polyurethane in the adhesive increases the alkali resistance and surface hardness, but makes the adhesive more difficult to remove or loosen. Increased alkali resistance can also be obtained by increasing the amount of the acrylic component with the lower acidic value (Carboset® 519), which makes the adhesive more difficult to remove.

If it is desired to put the down by screen printing it is desirable to add an ester alcohol and a diacetone alcohol. A formulation for screen printing comprises from about 15 to 35% by dry weight of an acrylic polymer and from 0.2 to 2% of the urethane polymer and from about 5 to 25% of an ester alcohol and 5 to 20% of diacetone alcohol with the balance being water. The preferred combination of acrylic and urethane polymers set forth above applies to this formulation as well. Preferably from 10 to 15% of this adhesive is an ester alcohol and 5 to 15% is diacetone alcohol. A volatile solvent can be added as a thinner and to control floating in the adhesive dispersion in an amount of 5 to 10% by weight of the adhesive. This volatile mixture may be a combination of toluene, acetone, methanol and 2-butoxyethanol. Preferably the ester alcohol is present in an amount of about 15% by weight and the diacetone alcohol is present in about 10% by weight.

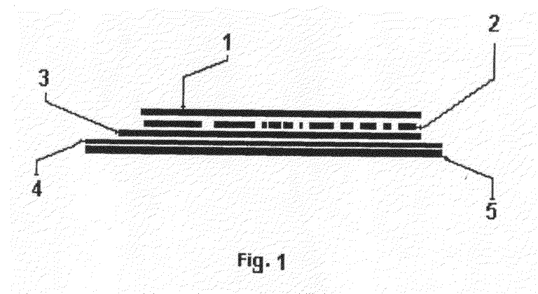

The decals with a transfer image of this invention are prepared by using a water-slide decal paper which is illustrated by the numeral 5 in FIG. 1 which is a cross-sectional view of the decal prepared in accordance with this invention. This decal paper has a water soluble coating numeral 4. A lacquer formulation of this invention is applied as a top coat 3 to this water soluble coating 4.

The lacquer formulation of this invention consists of approximately 20 to 30% by weight of cellulose acetate butyrate, 50 to 80% by weight of alcohol and 10 to 30% by weight of diacetone alcohol is used. Preferably approximately 23% by weight of cellulose acetate butyrate is used, 58% by weight of alcohol and 18.5% by weight of diacetone. The alcohol may be ethyl alcohol or denatured with a small amount of isopropyl alcohol (e.g. 5%).

This coating can be made more compatible for digital printing by adding from 1 to 7% of sucrose acetate isobutyrate to this formulation. Preferably from 3 to 5% of sucrose acetate isobutyrate is added, while approximately 4% is preferred. Preferably this formulation contains approximately 22% by weight of cellulose acetate butyrate, 56% by weight of alcohol, 18% of diacetone alcohol, and 4% of sucrose acetate isobutyrate.

The lacquer formulation of this invention can be applied as a top coat to form layer 3 by digitally printing, screen printing, offset printing or roll printing.

The printed image 2 can be printed on the transfer decal of this invention using any of the techniques for printing images on decal, including digital printing, screen printing and offset printing. A conventional solvent based printing ink or paint is used for printing the printed image 2.

Special effect particles can be added to add texture or reflection characteristics to either the top coat 3 or the image layer in the normal manner.

The adhesive of this invention as described above can then be applied as the back coat 1 in FIG. 1 by screen-printing, roll printing or other means of applying the adhesive. After the adhesive in the back coat 1 has dried, a plastic sheet such as a polypropylene sheet can be applied over the back coat 1 for stacking of transfer decals for shipment.

The back coating can also contain from 5 to 20% of an ester alcohol and a small percentage of organic solvent and liquid thinner to achieve the desired consistency. A diacetone alcohol could also be added to the back coating formulation. This back coating formulation can be diluted with additional alcohol to permit it to be applied by screen printing or by an ink jet printer.

After the transfer image decal has been prepared and dried thoroughly it can be applied to a painted surface or an unpainted surface by wetting, bringing into contact with the surface and removing the adhesive backing and scraping using a squeegee to smooth out the image.

The transfer image of this invention will remain securely adhered to a painted or unpainted surface even though it is washed with water through a car wash for example.

### The Remover Composition

Basically, the images that adhere to a painted or unpainted surface by the adhesive of this invention can be removed by contact with a combination of a tetrahydrofuryl alcohol and a dibasic ester and a surfactant. Preferably the removal solution has from 70 to 90% of tetrahydrafuryl alcohol, 5 to 15% dibasic ester and 0.2 to 1% of the emulsifying surfactant, all by weight. The dibasic esters may be derived from adipic, glutaric or succinic acids. The removal solution is simply brushed or sprayed onto the surface of the image and allowed to sit for a few minutes. The remover can then be rubbed into the image in a circular motion with the image beginning to break down. The remover is rubbed until the image is completely broken down. Once the remover had been thoroughly worked into the image, the pigment of the image will easily wipe away with water and a damp cloth or sponge.

Thus, a system is provided for putting a removable top coat over the image to be transferred and a removable adhesive which can be removed by the remover of this invention along with the image.

It should be emphasized that the above-described embodiments of the present invention are merely possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims.

### Example 1

An eight-gallon batch of the lacquer coating of this invention was made. Seven thousand grams of cellulose acetate butyrate (23.18% by weight) in powder form, Eastman Chemical CAB, 553-0-4, was dissolved in 17,600 grams of a mixture of 95% ethyl alcohol and 5% isopropyl alcohol (58.28% by weight) and 5,600 grams of diacetone alcohol (18.54% by weight). This clear coating was applied as a top coat to the surface of a sucrose base coated water release decal paper by a roller.

A backcoating adhesive was prepared from the components set forth in Table I. All of the components set forth in Table 1 except for the PROXEL were placed in a slow speed mixer and mixed together. The PROXEL GXL was diluted in water and then added to the mixture.

TABLE I

| | % | | |
|---|---|---|---|
| | BY WET | % BY DRY | WEIGHT |
| NAME OF COMPONENT | WEIGHT | WEIGHT | GRAMS |
| Carboset ® 514H manufactured | 81.46 | 32.58 | 21630.72 |
| by Noveon, Inc. | | | |
| Carboset ® 519 manufactured by | 15.02 | 6.00 | 3988.48 |
| Noveon, Inc. | | | |
| Sancure ® 875manufactured by | 2.81 | 0.98 | 745.92 |
| Noveon, Inc. | | | |
| Proxel GXL manufactured by | 0.05 | | 14.00 |
| Zeneca Corp. | | | |
| Water (filtered and sterilized) | 0.66 | | 174.00 |
| Totals | 100% | | 2653.12 |

The Carboset ® 514-H is an acrylic colloidal dispersion in which the acrylic has an acid number of about 65 and a hardness temperature (Tg) of about 28° C.
The Carboset ® 519 is also an acrylic colloidal dispersion in which the acrylic has an acid number of about 32 and a hardness temperature (Tg) of about 24° C.
The Sancure ® 815 is an aliphatic water-borne urethane polymer.
The Proxel GXL is a preservative and biocide.

The formulation obtained by mixing the ingredients in Table I is then mixed with ammonium hydroxide and water to achieve a final formulation set forth in Table II. The ammonium hydroxide is a solution of ammonium hydroxide and water in which the ammonia was present in an amount of 28% by weight. The pH of the final formulation was adjusted to between 8.0 and 8.5 by the use of ammonium hydroxide.

The back coating adhesive set forth was applied to the printed image of the decal by offset printing. The adhesive was allowed to dry and a polypropylene sheet was placed over the adhesive layer to protect it during shipping.

TABLE II

| | % BY WET | % BY DRY |
|---|---|---|
| NAME OF COMPONENT | WEIGHT | WEIGHT |
| Carboset 514-H | 55.1 | 22.04 |
| Carboset 519 | 10.16 | 4.06 |
| Sancure 815 | 1.9 | 0.67 |
| Proxel GXL | 0.04 | |
| Ammonium hydroxide (28%) | 0.98 | |
| Water | 31.83 | |
| Totals | 100% | |

The transfer image was applied to a painted surface of an automobile by putting the decal and placing the adhesive layer 1 against the surface of the automobile and sliding off the water slide paper 5 using a squeegee on the image to remove any wrinkles.

After the transfer image had dried on the painted surface to which it was applied, it was removed by a removal solution 88.1% by weight of tetra-hydrofurfuryl alcohol, 10% by weight of dibasic ester, 0.5% of emulsifying surfactant sold under the name Surfonic n-95 and 0.4% by weight of carboxymethyl cellulose sold under the name Methocell 311. The remover was rubbed on the surface of the image with a sponge and allowed to set for a few minutes and then agitated until the pigment of the image was dispersed. A wet cloth was then used to remove the image and adhesive restoring the painted surface to its original condition.

### Example 2

An eight-gallon batch of the lacquer coating of this invention was made by mixing the following ingredients. Seven thousand grams of cellulose acetate butyrate (22.29% by weight) in powder form, Eastman Chemical CAB-553-0-4, was dissolved in 17,600 grams of a mixture of 95% ethyl alcohol and 5% isopropyl alcohol (56.05% by weight) and 5,600 grams of diacetone alcohol (17.83% by weight) with 1200 grams of sucrose acetate isobutyrate (3.82%) sold by Eastman Chemical Co.

This top coating was printed on a sucrose base coated water release decal paper by an ink jet printer. An image was then printed onto to the top coat using screen printing. The backcoating adhesive of Example 1 was then applied to the image layer. After drying the decal with the transfer image was wet and applied to a painted metal surface in the same manner as set forth in Example 1.

After the decal had dried on the painted surface to which it was applied, it was removed by the removal solution of Example 1 in accordance with the procedure of Example 1.

### Example 3

An adhesive formulation of 18865.04 grams was prepared in accordance with Table III.

TABLE III

| | | % |
|---|---|---|
| | % BY WET | BY DRY |
| | WEIGHT | WEIGHT |
| Carboset ® 514-H manufactured by Noveon, | 52.88 | 21.15 |
| Inc. | | |
| Carboset ® 519 manufactured by Noveon, Inc. | 9.75 | 3.90 |
| Sancure ® 815 manufactured by Noveon, Inc. | 1.82 | 0.64 |
| Proxel GXL manufactured by Zeneca Corp. | 0.03 | |
| Water (filtered and sterilized) | 2.1 | |
| An ester alcohol sold under the name Texanol | 15.01 | |
| by Eastman Chemical Co | | |
| Volatile mixture to control floating sold under | 5.00 | |
| the name Rabo 3 by Raybo Chemical Co. | | |
| A mixture of toluene, acetone, 2- | 2.83 | |
| butoxyethanol, and methanol sold as Lacquer | | |
| thinner by Whitaker Oil Co. | | |
| Diacetone alcohol | 10.49 | |
| An optical brightener sold under the name | 0.08 | |
| Leucophor BCF ultra powder | | |
| Totals | 100.0% | |

A lacquer coating was prepared in accordance with the formula set forth in Example 2 and applied as a top coat by screen printing to the water release decal paper. An image was then printed on the top coat after it dried by an ink jet printer. After this had dried an adhesive prepared in accordance with the formula set forth in Table III was applied by screen printing to the image layer. The transfer image of the decal was transferred to a painted surface in the same manner as set forth in Example 3. After it had adhered to the surface it was removed by the remover solution of Example 1 in accordance with the procedure of Example 1.

After the decal had dried on the painted surface to which it was applied, it was removed by the removal solution of Example 1 in accordance with the procedure of Example 1.

### Example 4

An adhesive coating formulation was prepared in accordance with the formula of Example 3 and diluted with 60% alcohol by weight. The lacquer coating of Example 2 was put on the decal as a top coat in accordance with the procedure set forth in Example 2. An image was then printed by screen printing on the top coat. The adhesive formulation set forth above was then applied by screen printing. The decal with the transfer image was allowed to dry and was then applied to a painted surface in the same manner as set forth in Example 3.

After the decal had dried on the painted surface to which it was applied, it was removed by the removal solution of Example 1 in accordance with the procedure of Example 1.

It should be emphasized that the above-described embodiments of the present invention, particularly, any “preferred” embodiments, are merely possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims.

1. An easily removable adhesive which comprises:
a. from about 19 to about 34% by dry weight of an acrylic polymer;
b. from about 0.24 to 5% by dry weight of an aliphatic water-borne urethane polymer;
c. from 0.06 to 0.6% by weight of an alkali active matter; and
d. balance water

2. The adhesive of claim 1, wherein the acrylic polymer is present in an amount of from about 22 to 30% by dry weight and the aliphatic water-borne urethane polymer is present in an amount from about 0.4 to 1.2% by weight and the alkali is ammonium hydroxide which is present in an amount from 0.06 to 0.3% by weight of active matter.

3. The adhesive of claim 1, wherein the acrylic polymer is present in an amount of approximately 26% by dry weight and the aliphatic water-borne urethane polymer is present in an amount of approximately 0.7% by dry weight and the alkali is ammonium hydroxide which is present in an amount of approximately 0.28% by weight of active matter.

4. The adhesive of claim 1, wherein the acrylic polymer (a) comprises 19 to 26% by dry weight of an acrylic polymer with an acid number of between 60 and 70 and a hardness temperature (Tg) of between 26° C. and 30° C. and from about 2.4 to 6% by weight of an acrylic polymer with an acid number of between 28 and 34 and a hardness temperature (Tg) of between 22° C. and 26° C. and the aliphatic water-borne urethane polymer (b) is present in an amount of from about 0.4 to 1.2% by dry weight and this urethane polymer in dispersion has a viscosity (cP) of from 120 to 130 and a pH of 8+/−1.5 and the alkali (c) is ammonium hydroxide present in an amount of from about 0.06 to 0.6% by weight of active matter to achieve a pH of the composition of from 8 to 85 pH.

5. The adhesive of claim 1, in which the acrylic polymer (a) consists of approximately 22% by dry weight of an acrylic polymer having an acid number of approximately 65 and a hardness temperature (Tg) of 28° C. and approximately 4 by dry weight of an acrylic polymer with an acid number of approximately 32 and a hardness temperature (Tg) of 24° C., and a urethane polymer (b) has a viscosity (cP) in dispersion of approximately 125 and a pH of 8+/−1 and is present in an amount of approximately 0.7% by dry weight and the alkali (c) is ammonium hydroxide that is present in an amount of 0.3% by weight of active matter as needed to achieve a pH of the composition between 8 and 8.5.

6. An easily removable adhesive which comprises:
a. from about 15 to 35% by dry weight of an acrylic polymer;
b. from about 0.2 to 2% by dry weight of an aliphatic water-borne urethane polymer;
c. from about 5 to 25% by weight of an ester alcohol;
d. from about 5 to 20% by weight of diacetone alcohol; and
e. balance water.

7. The adhesive of claim 6, wherein the acrylic polymer (a) comprises from about 19 to 26% by dry weight an acrylic polymer with an acid number of between 60 and 70 and a hardness temperature (Tg) of between 26° C. and 30° C. and from about 2.4 to 6% by weight of an acrylic polymer with an acid number of between 28 and 34 and a hardness temperature (Tg) of between 22° C. and 26° C. and the aliphatic water-borne urethane polymer (b) is present in an amount of from about 0.4 to 1.2% by dry weight and this urethane polymer in dispersion has a viscosity (cP) of from 120 to 130 and a pH of 8+/−1.5 and the alkali (c) is ammonium hydroxide present in an amount of from about 0.06 to 0.6% by weight of active matter to achieve a pH of the composition of from 8 to 8.5 pH.

8. The adhesive of claim 7, further comprising a volatile solvent as a thinner and to control floating in the adhesive dispersion in an amount from about 5 to by weight of the adhesive.

9. The adhesive of claim 7, wherein the acrylic polymer (a) consists of approximately 22% by dry weight of an acrylic polymer having an acid number of approximately 65 and a hardness temperature (Tg) of 28° C. and approximately 4% by dry weight of an acrylic polymer with an acid number of approximately 32 and a hardness temperature (Tg) of 24° C., and a urethane polymer (b) has a viscosity (cP) in dispersion of approximately 125 and a pH of 8+/−1 and is present in an amount of approximately 0.7% by dry weight and the alkali (c) is ammonium hydroxide that is present in an amount of 0.3% by weight of active matter as needed to achieve a pH of the composition between 8 and 8.5 and the ester alcohol is present in an amount by weight of about 15% by weight and the diacetone alcohol is present in an amount of about 10% by weight.

10. The adhesive of claim 9, further comprising a volatile solvent as a thinner and to control floating in the adhesive dispersion in an amount from about 5 to 10% by weight of the adhesive.

11. A method for temporarily adhering a transfer image to a hard or sealed surface of an article which comprises applying the adhesive dispersion of claim 1 to a surface of the decal, allowing the adhesive to dry, wetting the adhesive and bringing the adhesive surface of the image into contact with the article and pressing the decal onto the surface of the article until it is adhered to the surface.

12-15. (canceled)

16. The method of claim 6 which further comprises removing the decal without damaging the surface of the article to which it was applied by applying a remover solution of from 70 to 90% by weight of tetrahydrafuryl alcohol, 5 to 10% by weight of a dibasic ester and from 0.2 to 1% by weight of an emulsifying surfactant and using the removal techniques of agitating the decal and waiting for the remover solution to act in order to remove the decal.

17. A system for temporarily adhering an image to a hard or sealed surface of an article and rapidly removing the decal which comprises:
a. securing a top coating and the image of the decal, the top coating when applied consisting of approximately 20 to 30% by weight of cellulose acetate butyrate, 50 to 80% by weight of alcohol and 10 to 30% by weight of diacetone alcohol;
b. securing an adhesive to the image which comprises from about 19 to 34 by dry weight of an acrylic polymer, from about 0.24 to 5% by dry weight of an aliphatic water-borne urethane polymer, and from 0.06 to 0.6% by weight of an alkali active matter;
c. wetting the image to be transferred and securing it to a hard surface, and
d. from 70 to 90% by weight of tetrahydrafuryl alcohol, 5 to 10% by weight of a dibasic ester and from 0.2 to 1% by weight of an emulsifying surfactant and using the removal techniques of agitating the decal and waiting for the remover solution to act in order to remove the decal.

18. The system of claim 17 in which the adhesive also includes from about 5 to 25% by weight of an ester alcohol and 5 to 20% by weight of a diacetone alcohol.
